(19) United States
(12) Patent Application Publication
(10) Pub. No.: US 2007/0083893 A1
(43) Pub. Date: Apr. 12, 2007

(54) Display apparatus and control method thereof

(75) Inventors: Young-hwa Yun, Seoul (KR); Sung-youn Pak, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/544,612

(22) Filed: Oct. 10, 2006

(30) Foreign Application Priority Data
Oct. 8, 2005 (KR) 10-2005-094669

(51) Int. Cl. H04N 5/445; G06F 3/00; G06F 13/00

(52) U.S. Cl. 725/44; 725/39; 725/45; 725/41

(57) ABSTRACT

An apparatus which facilitates displaying guide information related to a plurality of multimedia input signals includes a user-input unit which selects the guide information corresponding to the multimedia input signals desired by a user in order to display the selected guide information on the display unit; and a control unit which controls upper-hierarchical to lower-hierarchical guide information corresponding to the multimedia input signals selected through the user-input unit to be sequentially displayed on the display unit collectively and controlling a lowermost-hierarchical guide information among the displayed guide information to be most magnified and displayed on the display unit.

### CROSS-REFERENCE TO RELATED APPLICATIONS

This application claims the benefit under 35 U.S.C.§ 119 of Korean Patent Application No. 2005-0094669, filed on Oct. 8, 2005, the entire disclosure of which is hereby incorporated by reference.

### BACKGROUND OF THE INVENTION

1. Field of the Invention

Apparatuses and methods consistent with the present invention relate to a display apparatus and a control method thereof, and more particularly, to a display apparatus, which is capable of displaying and selecting information on a multimedia input signal desired by a user, of a plurality of multimedia input signals, and a control method thereof.

2. Description of the Related Art

With development of multimedia techniques, the amount of guide information on multimedia input signals provided from a variety of signal sources is increasing. An image signal or audio signal provided from a signal source, such as a digital camera, MP3 player, PVR (Personal Video Recorder) or the like, as well as a broadcasting signal provided from a broadcasting signal source contain guide information on the image, audio or broadcasting signal to be displayed on a display apparatus so that a user can view the guide information.

For example, a digital TV providing programs through a plurality of channels as well as a sky wave-based analog TV provide users with information on programs received from broadcasting stations or related service providers by means of an electronic program guide (EPG). In addition to the sky wave broadcasting, a variety of broadcasting signal sources including a wired broadcasting, cable TV, satellite broadcasting and the like increase the number of available channels more and more, which results in an increase of the amount of information on the programs, and accordingly, the use of EPG is being promoted.

The EPG is used to transmit program information, such as starting time or description about contents of programs being currently broadcasted or to be broadcasted later for a plurality of channels. Accordingly, using the information provided through the EPC; a user may refer to or select the content of a program desired by him/her, and, in addition, may reserve recording of the program.

Accordingly, if the user looks for a different desired channel or a broadcasting program to be reserved while he is watching a broadcasting program, he can obtain information on the desired channel or broadcasting program to be reserved by displaying a broadcasting program table according to the EPG on a display unit of the display apparatus (for example, TV) by means of predetermined input means, for example, a remote controller.

An interface such as a page system or a pop-up window is typically used to provide the user with the program information according to the EPG. In this case, however, the readability of the displayed program information is deteriorated or it is difficult for the user to understand the structure of the provided program information intuitively.

### SUMMARY OF THE INVENTION

Accordingly, it is an aspect of the present invention to provide a display apparatus, which is capable of displaying and selecting guide information on a multimedia input signal desired by a user, of a plurality of multimedia input signals and enhancing the readability of the displayed guide information, and a control method thereof.

The foregoing and/or other aspects of the present invention are achieved by providing a display apparatus having a display unit on which guide information related to a plurality of multimedia input signals is displayed, comprising: a user-input unit which selects the guide information corresponding to the multimedia input signals desired by a user in order to display the selected guide information on the display unit; and a control unit which controls upper-hierarchical to lower-hierarchical guide information corresponding to the multimedia input signals selected through the user-input unit to be sequentially displayed on the display unit collectively and controlling a lowermost-hierarchical guide information among the displayed guide information to be most magnified and displayed on the display unit.

According to an aspect of the present invention, when a desired area is selected from the upper-hierarchical guide information displayed on the display unit through the user-input unit, the control unit controls the lower-hierarchical guide information corresponding to the selected area to be magnified and displayed on the display unit and controls at least one different upper-hierarchical guide information in a hierarchy higher than the lower-hierarchical guide information to be reduced and displayed on the display unit.

According to another aspect of the present invention, the plurality of multimedia input signals comprise at least one of a broadcasting signal, an image signal and an audio signal.

According to another aspect of the present invention, if the multimedia input signal is activated, the control unit controls the corresponding lowermost-hierarchical guide information to be displayed on the display unit in an activated state, and, if the multimedia input signal is inactivated, the control unit controls the corresponding lowermost-hierarchical guide information to be displayed on the display unit by characters or images.

According to another aspect of the present invention, when the multimedia input signal is a broadcasting signal from a broadcasting signal source and the guide information is electronic program guide information regarding a broadcasting program according to the broadcasting signal, if guide information related to a channel being broadcasted is selected through the user-input unit for display on the display unit, the control unit controls a broadcasting picture of the channel with the lowermost-hierarchical guide information to be displayed on the display unit, and, if guide information related to a channel not being broadcasted is selected through the user-input unit for display on the display unit, the control unit controls a channel name, a title, a broadcasting time and a representative image of the channel with the lowermost-hierarchical guide information to be displayed on the display unit.

According to another aspect of the present invention, the guide information comprises electronic program guide information related to a broadcasting program according to a broadcasting signal from a broadcasting signal source.

The foregoing and/or other aspects of the present invention are achieved by providing a control method of a display apparatus having a display unit on which guide information related to a plurality of multimedia input signals is displayed, comprising: selecting the guide information corresponding to the multimedia input signal desired by a user through a user-input unit in order to display the selected guide information on the display unit; and controlling upper-hierarchical to lower-hierarchical guide information corresponding to the multimedia input signal selected through the user-input unit to be sequentially displayed on the display unit collectively and controlling a lowermost-hierarchical guide information among the displayed guide information to be most magnified and displayed on the display unit.

According to an exemplary embodiment of the present invention, when a desired area is selected from the upper-hierarchical guide information displayed on the display unit through the user-input unit, the lower-hierarchical guide information corresponding to the selected area is magnified and displayed on the display unit, and at least one different upper-hierarchical guide information in a hierarchy upper than the lower-hierarchical guide information is reduced and displayed on the display unit.

According to an exemplary embodiment of the present invention, the plurality of multimedia input signals comprise at least one of a broadcasting signal, an image signal and an audio signal.

According to an exemplary embodiment of the present invention, if the multimedia input signal is activated, the corresponding lowermost-hierarchical guide information is displayed on the display unit in an activated state, and, if the multimedia input signal is inactivated, the corresponding lowermost-hierarchical guide information is displayed on the display unit by characters or images.

According to an exemplary embodiment of the present invention, when the multimedia input signal is a broadcasting signal from a broadcasting signal source and the guide information is electronic program guide information regarding a broadcasting program according to the broadcasting signal, if guide information related to a channel being broadcasted is selected through the user-input unit for display on the display unit, a broadcasting picture of the channel with the lowermost-hierarchical guide information is displayed on the display unit, and, if guide information related to a channel not being broadcasted is selected through the user-input unit for display on the display unit, a channel name, a title, a broadcasting time and a representative image of the channel with the lowermost-hierarchical guide information are displayed on the display unit.

According to an exemplary embodiment of the present invention, the guide information comprises electronic program guide information related to a broadcasting program according to a broadcasting signal from a broadcasting signal source.

### BRIEF DESCRIPTION OF THE DRAWINGS

The above and/or other aspects of the present invention will become apparent and more readily appreciated from the following description of the embodiments, taken in conjunction with the accompanying drawings of which:

FIG. 1 is a schematic view showing configuration of a display apparatus according to an exemplary embodiment of the present invention;

FIG. 2 illustrates exemplary views showing sequentially guide information with a multiple-hierarchical structure in the display apparatus according to an exemplary embodiment of the present invention;

FIG. 3 is an exemplary view showing sequentially EPG information with a multiple-hierarchical structure in the display apparatus according to an exemplary embodiment of the present invention; and

FIGS. 4 and 5 are exemplary views showing the EPG information in detail in the display apparatus according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings.

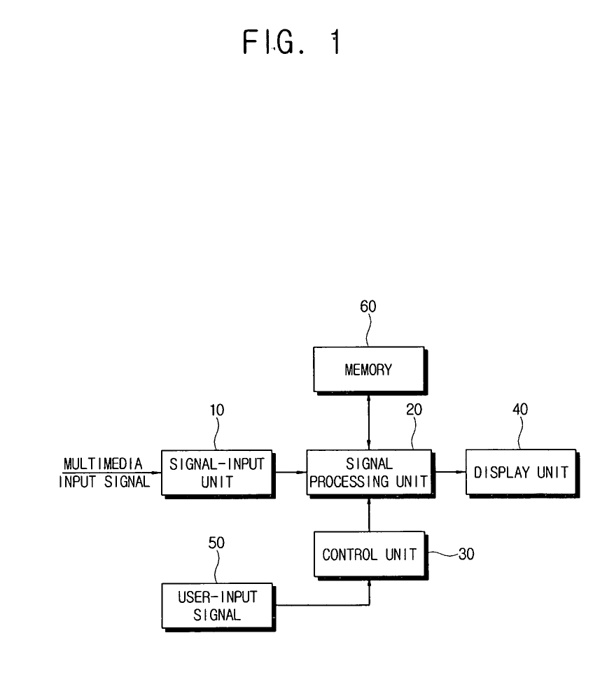

FIG. 1 is a block diagram showing schematically configuration of a display apparatus according to an exemplary embodiment of the present invention.

As shown in the figure, the display apparatus according to an exemplary embodiment of the present invention includes a display unit 40 on which a multimedia input signal input from a signal source is displayed through a process for the signal, a user-input unit 50 through which a user selects guide information corresponding to the multimedia input signal, which is displayed on the display unit 40, and a control unit 30 for displaying the selected guide information corresponding to the multimedia input signal on the display unit 40.

In this exemplary embodiment, the display apparatus may further include a signal-input unit 10 to which the multimedia input signal is input from the signal source, and a signal processing unit 20 for processing the multimedia input signal from the signal-input unit 10 into a format adapted to the display unit 40. The control unit 30 may be configured to control operation of parts of the display apparatus.

The signal-input unit 10 may be input with various multimedia input signals, such as analog/digital broadcasting signals, image signals or audio signals, from a variety of external signal sources, such as a digital camera, MP3 player, PVR or the like, as well as a broadcasting signal source. In addition, the signal-input unit 10 may be configured to be input with PC signals from a computer, video signals from a DVD device, set-top box or PVR, image signals stored in an external memory, etc.

For example, in the case of a digital TV, a coded broadcasting signal may be transformed into a transport stream, which may include an audio signal, a program information signal and so on, as well as an image signal, to be input to the signal-input unit 10. In addition, the signal-input unit 10 may include an antenna for receiving broadcasting signals and various interface units for receiving image signals and/or audio signals.

The signal processing unit 20 is configured to process an input signal input from the variety of signal sources via the signal-input unit 10. For example, the signal processing unit 20 may include a TMDS (Transition Minimized Differential Signaling) receiving unit, an A/D converter, a tuner, a video decoder and so on to process the input signal from the variety of signal sources. In addition, the signal processing unit 20 may be configured to include an audio decoder for transforming an audio signal separated from the transport stream.

In this exemplary embodiment, the user-input unit 50 may be prepared as a wired/wireless remote controller provided with function selection keys and top/bottom/left/right directional key buttons for selecting items on the display unit 40. In addition, the user-input unit 50 may include operation buttons provided in the front of the display apparatus and a key signal generating part for generating a key signal in response to key operation of the operation button. In addition, the user-input unit 50 may be prepared as a separate general-purpose input device, for example, a mouse, a key board or a stylus pen, or may be of a touch screen type. Key signals generated in response to operation of the key buttons or the operation buttons of the user-input unit 50 are applied to the control unit 30 to execute a required operation according to the applied key signals. In addition, the control unit 30 may control parts of the display apparatus in response to the key signals input from the user-input unit 50.

Such various multimedia input signals may be provided with additional guide information regarding the input signals. The guide information is configured to include a multiple-hierarchical structure and is displayed on the display unit 40 when the guide information is selected through the user-input unit 50. In addition, the guide information may be configured to be stored in a memory 60 provided in the display apparatus.

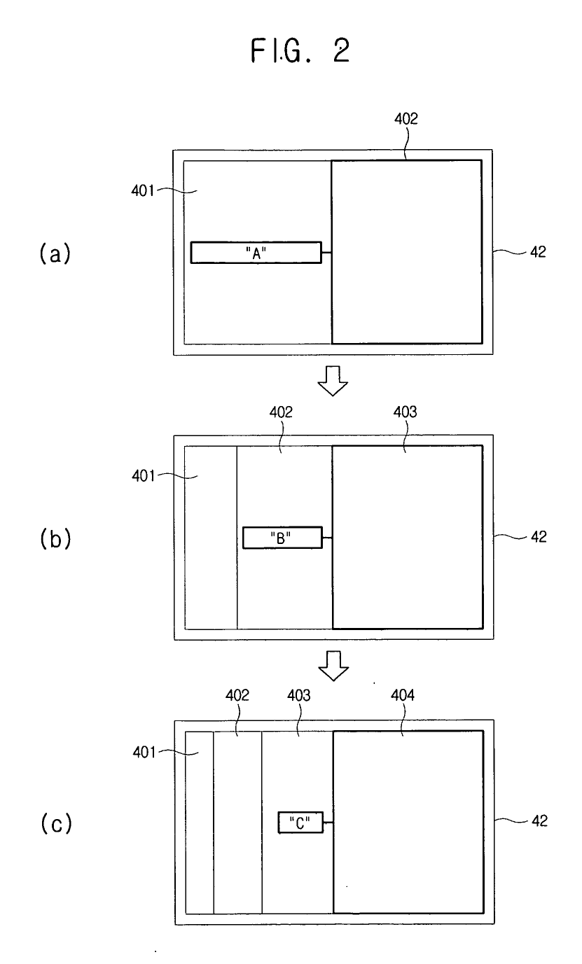

FIG. 2 shows an example where the guide information includes a four-hierarchical structure. When the guide information is selected through the user-input unit 50, first-hierarchical guide information 401, which is the uppermost hierarchical guide information, is displayed throughout a screen 42 of the display unit 40, although not shown in the figures.

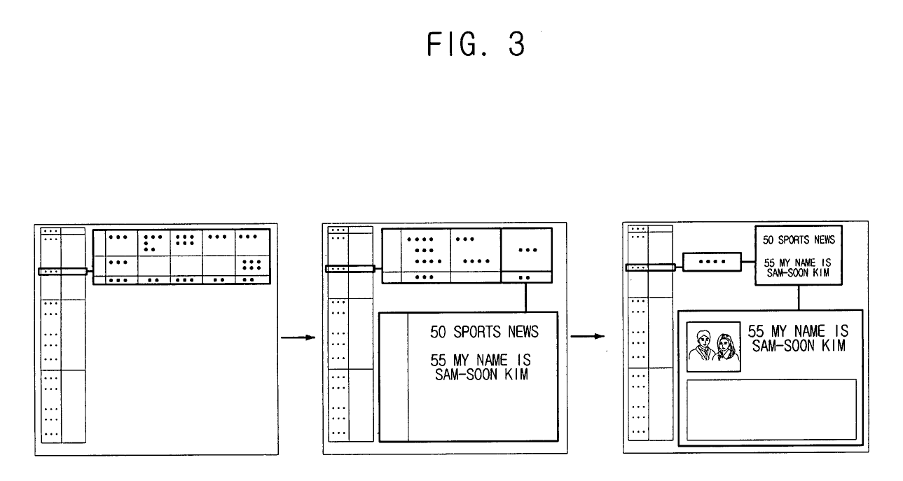

For the purpose of convenience of explanation, by way of example where a terrestrial or satellite digital TV provides programs through a plurality of channels, as well as a sky wave-based analog TV provides a user with information on programs received from broadcasting stations or related service providers as EPG information, a method of displaying the EPG information with the four-hierarchical structure on the display apparatus will be described in detail with reference to FIGS. 2 and 3.

In FIG. 2, screen (a) shows that details on an “A’ item selected from the first-hierarchical guide information 401 through the user-input unit 50 is displayed on the screen 42 of the display unit 40 as second-hierarchical guide information 402 by the control unit 30. Here, when the “A” item is selected from the first-hierarchical guide information 401, the control unit 30 controls the corresponding second-hierarchical guide information 402 to be magnified and the remaining items except the “A” item to be reduced.

FIG. 3 shows an example where, if the multimedia input signal is a broadcasting signal, guide information on the broadcasting signal is provided as EPG information. In FIG. 3, first-hierarchical EPG information is collectively displayed on the screen 42 of the display unit 40, with program guide information for each channel separated for each broadcasting time zone on every broadcasting date, although not shown in the figure. In the condition where the first-hierarchical EPG information is displayed, when a broadcasting time zone of a particular date is selected through the user-input unit 50, the control unit 30 controls the program guide information for each channel broadcasted in a corresponding time zone to be magnified as second-hierarchical EPG information (indicated in the right portion of the screen in a left figure of FIG. 3) on the display unit 40, together with the first-hierarchical EPG information. Thus, the initially displayed first-hierarchical EPG information is shown to be reduced (indicated in the left portion of the screen in the left figure of FIG. 3).

Subsequently, when a desired “B” item is selected from the second-hierarchical guide information 402 using a key button or the like provided in the user-input unit 50, the control unit 30 controls details of the “B” item to be magnified as third-hierarchical guide information 403 on the screen 42 of the display unit 40 and the remaining items except the “B” item to be reduced on the screen 42 of the display unit 40, as shown in screen (b) of FIG. 2.

Referring to FIG. 3 again, when a particular channel in the corresponding broadcasting time zone is selected from the second-hierarchical EPG information through the user-input unit 50, the control unit 30 controls program guide information for the selected channel to be magnified as third-hierarchical EPG information (indicated in the right lower portion of the screen in a central figure of FIG. 3) on the display unit 40, together with the first and second-hierarchical EPG information. Thus, the previously displayed first and second-hierarchical EPG information is shown to be reduced.

Finally, when a desired “C” item is selected from the third-hierarchical guide information 403 through the user-input unit 50, the control unit 30 controls details of the “C” item to be magnified as fourth-hierarchical guide information 404 on the screen 42 of the display unit 40 and the remaining items except the “C” item to be reduced on the screen 42 of the display unit 40, as shown in screen (c) of FIG. 2.

Referring to FIG. 3 again, when user selects a desired program in the corresponding channel from the third-hierarchical EPG information through the user-input unit 50, the control unit 30 controls guide information of the selected program to be magnified as fourth-hierarchical EPG information (indicated in the right lower portion of the screen in a right figure of FIG. 3) on the display unit 40, together with the first, second and third-hierarchical EPG information. Thus, the previously displayed first, second and third-hierarchical EPG information is shown to be reduced.

In the above exemplary embodiment, when the guide information having the multiple-hierarchical structure is collectively displayed, while it is shown in FIG. 2 that the lowermost hierarchical guide information is magnified to occupy about half of the screen and other upper-hierarchical guide information is reduced to occupy the other half of the screen at a specified ratio, a display ratio and a display position of each hierarchical guide information may be appropriately adjusted. For example, in the case of the EPG information shown in FIG. 3, the first-hierarchical EPG information is configured to be in a fixed position, with the information reduced at a specified ratio on the left side of the screen, while the next-hierarchical EPG information is being displayed. In addition, the second-hierarchical EPG information and the third-hierarchical EPG information are configured to be arranged in parallel on the right and top sides of the screen, and the fourth-hierarchical EPG information is configured to be magnified on the right and bottom sides of the screen.

As described above, the control unit 30 controls the upper-hierarchical to lower-hierarchical guide information corresponding to the multimedia input signal selected through the user-input unit 50 to be sequentially displayed on the screen 42 of the display unit 40 collectively, and controls the respective lowermost-hierarchical guide information (for example, 402, 403 and 404 in FIG. 2) among the guide information displayed whenever the guide information of hierarchies corresponding to a desired item is displayed to be most magnified and displayed on the screen 42.

In addition, when a desired area (“A” item) is selected from upper-hierarchical guide information (for example, 401 in FIG. 2) displayed on the screen 42 of the display unit 40 through the user-input unit 50, the control unit 30 controls the next lower-hierarchical guide information (for example, 402 in FIG. 2) corresponding to the selected area to be magnified and displayed on the screen 42 of the display unit 40. Accordingly, the control unit 30 controls at least one different upper-hierarchical guide information 401 in a hierarchy higher than the lower-hierarchical guide information 402 to be reduced and displayed on the screen 42 of the display unit 40.

In the meantime, if the multimedia input signal is activated, the control unit 30 controls the corresponding lowermost-hierarchical guide information to be displayed on the screen 42 of the display unit 40 in an activated state (see 404 in FIG. 2). If the multimedia input signal is inactivated, the control unit 30 controls the corresponding lowermost-hierarchical guide information to be displayed on the screen 42 of the display unit 40 by characters or images (see 404 in FIG. 2).

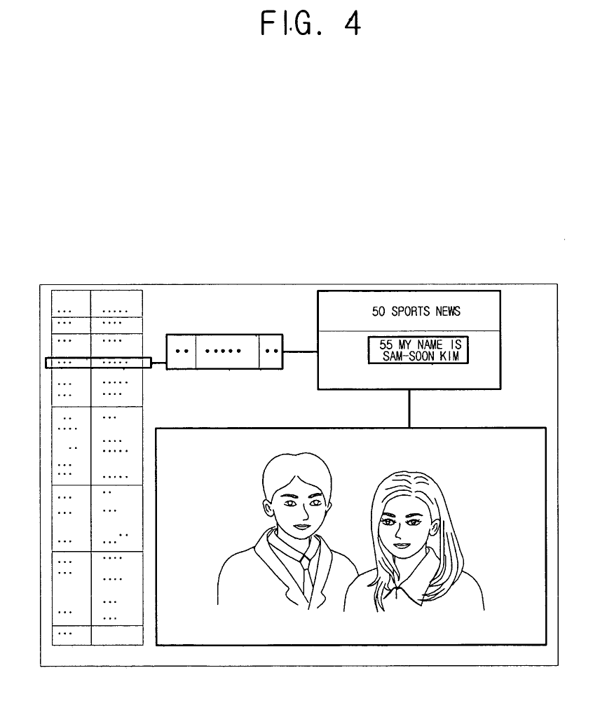

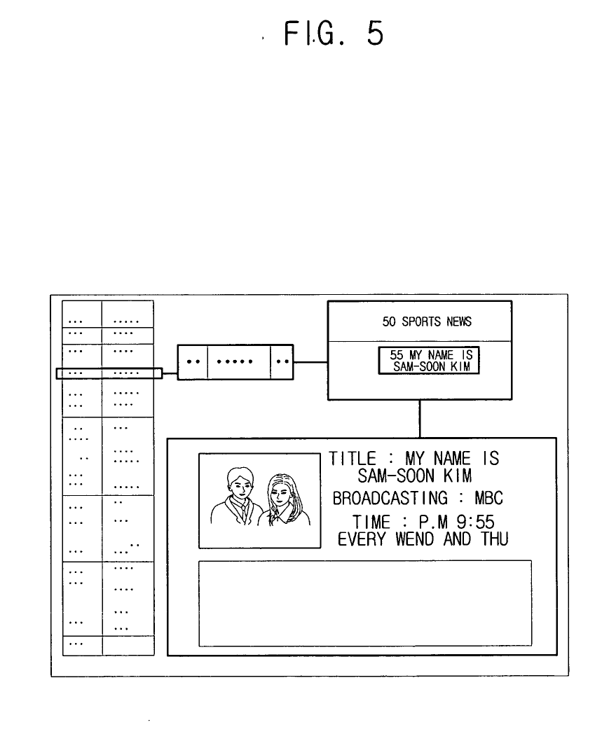

For example, assuming the multimedia input signal is a broadcasting signal from the broadcasting signal source and guide information is EPG information regarding a program according to the broadcasting signal, if guide information related to a channel being lastly broadcasted is selected through the user-input unit 50 for display on the screen 42, the control unit 30 controls a currently broadcasting picture of the channel with the lowermost-hierarchical guide information, i.e., the fourth-hierarchical EPG information, to be displayed on the screen 42 of the display unit 40 (see FIG. 4). In addition, if guide information related to a channel not being lastly broadcasted is selected through the user-input unit 50 for display on the screen 42, the control unit 30 controls a channel name, a title, a broadcasting time, a representative image and the like of the channel with the lowermost-hierarchical guide information, i.e., the fourth-hierarchical EPG information, to be displayed on the screen 42 of the display unit 40 (see FIG. 5).

As discussed above, in the display apparatus of the present invention, since all of the upper-hierarchical to lower-hierarchical guide information related to a predetermined multimedia input signal having the multiple-hierarchical structure can be collectively displayed on the screen 42 of the display unit 40, a user can intuitively grasp a structure of the guide information related to a provided input signal without difficulty. In addition, since the guide information of a hierarchy corresponding to a desired item is magnified and displayed on the screen 42 of the display unit 40, readability of the guide information may be enhanced.

In addition to the guide information related to the broadcasting signal, such as the above-described EPG information, record information related to an image signal recorded in a PVR device, photographing information of a photographing date, image size, photographing device and the like related to an image signal stored in an external memory, sound information of a title, reproduction time and the like related to an audio signal, etc. may also be constructed as multiple-hierarchical structure for display in the display apparatus according to the exemplary embodiment of the present invention.

As apparent from the description, according to the display apparatus and the control method of the present invention, readability of the guide information related to the multimedia input signal, such as the EPG information for the broadcasting signal, may be enhanced, and a user may intuitively grasp the structure of the guide information without difficulty.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An apparatus which facilitates h displaying guide information related to a plurality of multimedia input signals on a display unit, comprising:
a user-input unit which selects the guide information corresponding to the plurality of multimedia input signals in order to display the selected guide information on the display unit; and
a control unit which controls upper-hierarchical to lower-hierarchical guide information corresponding to the plurality of multimedia input signals selected through the user-input unit to be sequentially displayed on the display unit and which controls a lowermost-hierarchical guide information among the displayed guide information to be most magnified and displayed on the display unit.

2. The apparatus according to claim 1, wherein, when a desired area is selected from the upper-hierarchical guide information displayed on the display unit through the user-input unit, the control unit controls the lower-hierarchical guide information corresponding to the selected area to be magnified and displayed on the display unit and controls at least one different upper-hierarchical guide information in a hierarchy higher than the lower-hierarchical guide information to be reduced and displayed on the display unit.

3. The apparatus according to claim 1, wherein the plurality of multimedia input signals comprise at least one of a broadcasting signal, an image signal and an audio signal.

4. The apparatus according to claim 3, wherein, if a multimedia input signal corresponding to the displayed guide information is activated, the control unit controls the corresponding lowermost-hierarchical guide information to be displayed on the display unit in an activated state, and, if the multimedia input signal is inactivated, the control unit controls the corresponding lowermost-hierarchical guide information to be displayed on the display unit by characters or images.

5. The apparatus according to claim 4, wherein, when the multimedia input signal is a broadcasting signal from a broadcasting signal source and the guide information is electronic program guide information regarding a broadcasting program according to the broadcasting signal, if guide information related to a channel being broadcasted is selected through the user-input unit for display on the display unit, the control unit controls a broadcasting picture of the channel with the lowermost-hierarchical guide information to be displayed on the display unit, and, if guide information related to a channel not being broadcasted is selected through the user-input unit for display on the display unit, the control unit controls a channel name, a title, a broadcasting time and a representative image of the channel with the lowermost-hierarchical guide information to be displayed on the display unit.

6. The apparatus according to claim 2, wherein, if a multimedia input signal corresponding to the displayed guide information is activated, the control unit controls the corresponding lowermost-hierarchical guide information to be displayed on the display unit in an activated state, and, if the multimedia input signal is inactivated, the control unit controls the corresponding lowermost-hierarchical guide information to be displayed on the display unit by characters or images.

7. The apparatus according to claim 6, wherein, when the multimedia input signal is a broadcasting signal from a broadcasting signal source and the guide information is electronic program guide information regarding a broadcasting program according to the broadcasting signal, if guide information related to a channel being broadcasted is selected through the user-input unit for display on the display unit, the control unit controls a broadcasting picture of the channel with the lowermost-hierarchical guide information to be displayed on the display unit, and, if guide information related to a channel not being broadcasted is selected through the user-input unit for display on the display unit, the control unit controls a channel name, a title, a broadcasting time and a representative image of the channel with the lowermost-hierarchical guide information to be displayed on the display unit.

8. The apparatus according to claim 1, wherein, if a multimedia input signal corresponding to the displayed guide information is activated, the control unit controls the corresponding lowermost-hierarchical guide information to be displayed on the display unit in an activated state, and, if the multimedia input signal is inactivated, the control unit controls the corresponding lowermost-hierarchical guide information to be displayed on the display unit by characters or images.

9. The apparatus according to claim 8, wherein, when the multimedia input signal is a broadcasting signal from a broadcasting signal source and the guide information is electronic program guide information regarding a broadcasting program according to the broadcasting signal, if guide information related to a channel being broadcasted is selected through the user-input unit for display on the display unit, the control unit controls a broadcasting picture of the channel with the lowermost-hierarchical guide information to be displayed on the display unit, and, if guide information related to a channel not being broadcasted is selected through the user-input unit for display on the display unit, the control unit controls a channel name, a title, a broadcasting time and a representative image of the channel with the lowermost-hierarchical guide information to be displayed on the display unit.

10. The apparatus according to claim 1, wherein the guide information comprises electronic program guide information related to a broadcasting program according to a broadcasting signal from a broadcasting signal source.

11. A control method of an apparatus which facilitates displaying guide information related to a plurality of multimedia input signals, comprising:
selecting the guide information corresponding to one of the plurality of multimedia input signals through a user-input unit in order to display the selected guide information on the display unit; and
controlling upper-hierarchical to lower-hierarchical guide information corresponding to the one of the plurality of multimedia input signals selected through the user-input unit to be sequentially displayed on the display unit and controlling a lowermost-hierarchical guide information among the displayed guide information to be most magnified and displayed on the display unit.

12. The control method according to claim 11, wherein, when a desired area is selected from the upper-hierarchical guide information displayed on the display unit through the user-input unit, the lower-hierarchical guide information corresponding to the selected area is magnified and displayed on the display unit, and at least one different upper-hierarchical guide information in a hierarchy higher than the lower-hierarchical guide information is reduced and displayed on the display unit.

13. The control method according to claim 11, wherein the plurality of multimedia input signals comprise at least one of a broadcasting signal, an image signal and an audio signal.

14. The control method according to claim 13, wherein, if a multimedia input signal corresponding to the displayed guide information is activated, the corresponding lowermost-hierarchical guide information is displayed on the display unit in an activated state, and, if the multimedia input signal is inactivated, the corresponding lowermost-hierarchical guide information is displayed on the display unit by characters or images.

15. The control method according to claim 14, wherein, when the multimedia input signal is a broadcasting signal from a broadcasting signal source and the guide information is electronic program guide information regarding a broadcasting program according to the broadcasting signal, if guide information related to a channel being broadcasted is selected through the user-input unit for display on the display unit, a broadcasting picture of the channel with the lowermost-hierarchical guide information is displayed on the display unit, and, if guide information related to a channel not being broadcasted is selected through the user-input unit for display on the display unit, a channel name, a title, a broadcasting time and a representative image of the channel with the lowermost-hierarchical guide information are displayed on the display unit.

16. The control method according to claim 12, wherein, if a multimedia input signal corresponding to the displayed guide information is activated, the corresponding lowermost-hierarchical guide information is displayed on the display unit in an activated state, and, if the multimedia input signal is inactivated, the corresponding lowermost-hierarchical guide information is displayed on the display unit by characters or images.

17. The control method according to claim 16, wherein, when the multimedia input signal is a broadcasting signal from a broadcasting signal source and the guide information is electronic program guide information regarding a broadcasting program according to the broadcasting signal, if guide information related to a channel being broadcasted is selected through the user-input unit for display on the display unit, a broadcasting picture of the channel with the lowermost-hierarchical guide information is displayed on the display unit, and, if guide information related to a channel not being broadcasted is selected through the user-input unit for display on the display unit, a channel name, a title, a broadcasting time and a representative image of the channel with the lowermost-hierarchical guide information are displayed on the display unit.

18. The control method according to claim 11, wherein, if a multimedia input signal corresponding to the displayed guide information is activated, the corresponding lowermost-hierarchical guide information is displayed on the display unit in an activated state, and, if the multimedia input signal is inactivated, the corresponding lowermost-hierarchical guide information is displayed on the display unit by characters or images.

19. The control method according to claim 18, wherein, when the multimedia input signal is a broadcasting signal from a broadcasting signal source and the guide information is electronic program guide information regarding a broadcasting program according to the broadcasting signal, if guide information related to a channel being broadcasted is selected through the user-input unit for display on the display unit, a broadcasting picture of the channel with the lowermost-hierarchical guide information is displayed on the display unit, and, if guide information related to a channel not being broadcasted is selected through the user-input unit for display on the display unit, a channel name, a title, a broadcasting time and a representative image of the channel with the lowermost-hierarchical guide information are displayed on the display unit.

20. The control method according to claim 11, wherein the guide information comprises electronic program guide information related to a broadcasting program according to a broadcasting signal from a broadcasting signal source.
